(19) United States
(12) Patent Application Publication
(10) Pub. No.: US 2023/0247989 A1
(43) Pub. Date: Aug. 10, 2023

(54) Synergistic Biocide Composition With a Polyglycerol Ester

(71) Applicant: Arch UK Biocides Ltd, Castleford, West Yorkshire (GB)

(72) Inventors: James Clarke, Castleford, West Yorkshire (GB); Aaron Nightingale, Castleford, West Yorkshire (GB); Matt Bromfield, Castleford, West Yorkshire (GB); Paul Wheeler, Castleford, West Yorkshire (GB); Jordan Petkov, Castleford, West Yorkshire (GB); Neil Scott Shaw, Castleford, West Yorkshire (GB); Elias Pambou, Castleford, West Yorkshire (GB)

(21) Appl. No.: 17/920,199

(22) PCT Filed: Apr. 22, 2021
(86) PCT No.: PCT/EP2021/060524

§ 371 Date: Oct. 20, 2022

(30) Foreign Application Priority Data
Apr. 23, 2020 (EP) 20171207.2

(51) Int. Cl. A01N 37/02; A01N 33/12; A01N 47/44; A01N 31/02; A01N 33/02; A01P 1/00

(52) U.S. Cl. CPC A01N 37/02; A01N 33/12; A01N 47/44; A01N 31/02; A01N 33/02; A01P 1/00

(57) ABSTRACT

Provided herein are disinfecting compositions of a biocidal agent with a polyglycerol ester having a synergistic effect which allow for a reduction in the amount of the biocidal agent necessary to be an effective disinfecting composition.

### FIELD OF INVENTION

The present disclosure relates to a biocidal composition with enhance biocidal properties as compared with compositions with a single biocide.

### BACKGROUND OF THE INVENTION

A disinfectant refers to any chemical agent/composition capable of killing, destroying, or inhibiting the growth of organisms, particularly microorganisms. Disinfectant products include hard surface cleaners, hand and skin sanitizers, hand and skin cleaners, pre-disinfectant cleaners for instruments, sterilizing and high-level disinfectant compositions, and soft surface disinfection, such as laundry detergents, fabric and upholstery cleaning agents and disinfectants, and the like.

Ideally, a disinfectant composition has broad-spectrum activity against all types of microorganisms at various pH levels. The disinfectant composition should also have high efficacy so that a minimum amount of a biocidal agent can be used to save cost and to avoid or reduce any possible adverse effects caused by the biocidal agent. Also, it is desirable that the disinfectant composition is stable to any changes in temperature encountered during manufacturing, packaging, and shipping as well as during storage. Further, an ideal disinfectant composition is physically and chemically compatible with ingredients of different application systems and compatible with the different components present in the end-use formulation so that the disinfectant composition can suitably be incorporated in various end-use products.

In recent developments in the disinfectant arts, there has been considerable effort given to find compounds that will synergistically interact with the biocidal agent in a disinfectant composition in order to boost the efficacy of the biocidal agent and/or to effectively reduce the amount of biocidal agent needed in the disinfectant composition to have an disinfectant composition with desired disinfecting properties whilst using the least amount of the biocidal agent in the disinfectant formulation. The present disclosure provides an answer to that need, by providing a synergistic mixture of a biocidal agent with a polyglycerol ester compound present in the disinfectant composition.

### SUMMARY OF THE INVENTION

In a first embodiment, provided is a disinfecting composition containing (i) a biocidal agent; and (ii) a polyglycerol ester. The polyglycerol ester is present in an amount to sufficiently increase the efficacy of the biocidal agent as compared to the biocidal agent alone, and the increase is greater than the additive effect of the biocidal activity of the biocidal agent and polyglycerol ester taken alone.

In another embodiment, provided is disinfecting composition according the first embodiment wherein the weight ratio of the polyglycerol ester to the biocidal agent is in the range of 0.00001 to 10.0, in particular in the range of 0.0001 to 2.0, more particularly in the range of 0.001 to 1.5, and even more particularly in the range of 0.01 to 1.0.

In a further embodiment, the disinfecting composition contains a biocidal agent which is quaternary ammonium compound, a tertiary amine, a guanide, a biguanide, an alcohol, a phenolic compound an organic acid, peroxide, a peracid, an iron chelator, a pyridine compound, an iodine compound or mixtures thereof.

In yet another embodiment, the disinfecting composition the biocidal agent is a tertiary amine which is a (C8-C16) alkyl tertiary amine, such as N,N-bis(3-aminopropyl)dodecyl-1,3 propane amine.

In yet a further embodiment, the disinfecting composition contains a biocidal agent which is a quaternary ammonium compound. Quaternary ammonium compound include compounds such as an alkyl quaternary ammonium compound, a benzyl quaternary ammonium compound. Examples of the alkyl quaternary ammonium compound include di C8-18 alkyl dimethyl ammonium compound or a benzyl C8-18 alkyl dimethyl ammonium compound. The quaternary ammonium compounds typically have a salt anion, which is a halide, a carbonate, a bicarbonate/carbonate, a carboxylate, sulfonate or a phosphate.

In another aspect of the present disclosure, in the disinfecting composition the biocidal agent is a guanide. Guanides include a biguande, for example, polyhexamethylene monoguanide, or polyhexamethylene biguanide, or chlorhexidine.

In another aspect of the present invention, the biocidal agent may be an acid.

In a further aspect, the disinfecting composition contains a biocidal agent which is para-chlorometaxylenol, pyridinol-1-oxide (HPNO), octenidine, or povidone-iodine.

In another embodiment, the disinfecting composition contains a polyglycerol ester which is derived from (a) a polyglycerol component built up from 2 to 12 molecules of glycerol, based on an average, and (b) a fatty acid comprises a caprylic acid, capric acid, lauric acid, myristic acid, palmitic acid, stearic acid, arachidic acid, behenic acid, lignoceric acid, cerotic acid, oleic acid, or decaoleic acid. Particular polyglyceryl fatty esters include one or more of a polyglyceryl-10 laurate, polyglyceryl-10 decaoleate; polyglyceryl-3 monostearate; polyglyceryl-6 distearate, polyglyceryl-10 stearate; polyglyceryl-10 oleate; polyglyceryl-10 dipalmitate, or polyglyceryl-10 caprylate/caprate.

In a further embodiment, provided is a method for increasing the efficacy of a biocidal agent in a disinfecting solution. The method includes providing a biocidal agent and adding an effective amount of a polyglycerol ester to the biocidal agent to increase the efficacy of the biocidal agent as compared to an equal amount of biocidal agent without the polyglycerol ester.

In another embodiment, provided is a method of increasing the efficacy of a hard surface disinfection composition. The method includes providing a hard surface disinfection composition, and adding an effective amount of a polyglycerol ester to the hard surface disinfection composition. The addition of the polyglycerol ester increases the efficacy of the hard surface disinfection composition as compared to a hard surface disinfection composition without the polyglycerol ester.

In another embodiment, provided is a method of increasing the efficacy of a soft surface disinfection composition. The method includes providing a soft surface disinfection composition, and adding an effective amount of a polyglycerol ester to the soft surface disinfection composition. The addition of the polyglycerol ester increases the efficacy of the soft surface disinfection composition as compared to a soft surface disinfection composition without the polyglycerol ester.

In a further embodiment of the present invention, provided is a method of reducing the minimum amount biocidal agent needed for effective biocidal activity. The method includes providing a biocidal agent, and adding an amount of a polyglycerol ester to the biocidal agent to form a disinfecting composition. The minimum amount of the biocidal agent need for effective biocidal activity is less in the disinfecting composition with the polyglycerol ester as compared to a composition where the biocidal agent was used alone.

These and other aspects will become apparent when reading the detailed description of the invention.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to a disinfectant composition. As used herein, the term “disinfectant” means a biocidal composition which are intended to be applied to a surface to destroy microorganisms which are living on the surface. The disinfectant composition of the present disclosure has numerous uses and applications. The disinfectant can be used in any suitable industry or field where surfaces need to be essentially free of microorganisms. For instance, the disinfectant may comprise an institutional product, a domestic product, or a healthcare product. The disinfectant, for instance, may comprise a hard surface disinfectant, a hand sanitizer, a sterilizing or high-level disinfectant composition, a pre-disinfectant cleaner for instruments, soft surface disinfection such as a disinfectant ingredient in a laundry detergent, upholster and fabric cleaner/disinfectant and the like. In one particular use, they can be used in the food and beverage field for cleaning food contact surfaces, such as counters, food service tables, food containers and the like. Generally, food contact approved disinfectants have a relatively low amount of the biocidal agent.

It has now been surprisingly found that adding an amount of a polyglycerol ester to a biocidal agent for use in a disinfectant composition can provide an effective disinfectant composition with a synergistic interaction between the biocidal agent and the polyglycerol ester. As used herein, a “synergistic interaction” refers to the fact that the biocidal agent, when combined together the polyglycerol ester have a total effect that is greater than the biocide properties of the biocide alone, or the polyglycerol ester alone. In other words, the biocidal agent of the present disclosure operate synergistically with the polyglycerol ester so as to have greater antimicrobial activity in the presence of each against a certain microorganisms than in comparison to the antimicrobial activity of the biocidal agent alone or the antimicrobial activity of the polyglycerol ester alone at the same concentrations. Due to the synergistic effect, the amount of the biocidal agent present in the disinfecting composition can be reduced while still producing the desired efficacy. This effect is also known as potentiation of the biocidal agent in the disinfectant composition. This potentiation of the biocidal is also referred to herein as a “synergistic effect” between the biocidal agent and the polyglycerol esters for boosting the efficacy of the biocidal agent.

In one embodiment, the biocidal agent may comprise a quaternary ammonium compound. The quaternary ammonium compound may comprise, for instance, an alkyl quaternary ammonium compound or a benzyl ammonium compound. Quaternary ammonium compounds, also known as “quats”, typically comprise at least one quaternary ammonium cation with an appropriate anion. Quats will generally have the general Formula I:

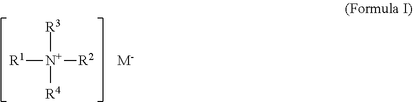

The groups R¹, R², R³ and R⁴ can vary within wide limits and examples of quaternary ammonium compounds that have anti-microbial properties will be well known to the person of ordinary skill in the art. Typically, two of R¹, R², R³ and R⁴ are lower alkyl, meaning having 1 to 4 carbon atoms, such as methyl, ethyl, propyl or butyl groups. In addition, two of R¹, R², R³ and R⁴ are longer chain alkyl groups of 6 to 24 carbon atoms which may be straight chained or branched, or a benzyl group. M⁻ is a monovalent anion or one equivalent of a polyvalent anion of an inorganic or organic acid. Suitable anions for M⁻ are in principle all inorganic or organic anions, in particular halides, for example chloride or bromide, carboxylates, sulfonates, phosphates, carbonate, a bicarbonate/carbonate or a mixture thereof. In one embodiment, the quaternary ammonium compound may have the following R groups: R¹ is benzyl or C₆₋₁₈-alkyl, R² is C₁₋₁₈-alkyl or —[(CH₂)₂—O]ₙR₅ where n=1-20, R³ and R⁴ independently of one another are C₁₋₄-alkyl, R⁵ is hydrogen or unsubstituted or substituted phenyl, and M⁻ is a monovalent anion or one equivalent of a polyvalent anion of an inorganic or organic acid.

In one embodiment, the quaternary ammonium compound may comprise a dialkyl ammonium compound, such as a dimethyl dialkyl ammonium compound. In one embodiment, the dimethyl dialkyl ammonium compound may have between about 8 and about 12 carbon atoms, such as from about 8 to about 10 carbon atoms in each of the alkyl groups.

Examples of dimethyl dialkyl ammonium compounds which may be used as the first biocide include dimethyl dioctyl ammonium compounds such as dimethyl dioctyl ammonium chloride, dimethyl didecyl ammonium compounds such as dimethyl didecyl ammonium chloride and the like. Mixtures of dimethyl dialkyl ammonium compounds may also be used and other anions, such as those described above may also be used. Commercially available dimethyl dialkyl ammonium compounds include, for example, compositions marketed and sold under the BARDAC™ tradename by Lonza America, Inc.

In an alternative embodiment, the first biocide may comprise a benzyl ammonium compound, such as an alkyl dimethyl benzyl ammonium compound. In general, the alkyl group may contain from about 10 to about 18 carbon atoms, such as from about 12 to about 16 carbon atoms.

Examples of alkyl dimethyl benzyl ammonium compounds useable as the first biocide include C12 alkyl dimethyl benzyl ammonium chloride, C14 alkyl dimethyl benzyl ammonium chloride, and C16 alkyl dimethyl benzyl ammonium chloride. In addition, a mixture of these alkyl dimethyl benzyl ammonium compounds can be used. Commercially available alkyl dimethyl benzylammonium compounds include, for example, compositions marketed and sold under the BARQUAT® tradename by Lonza America, Inc. These commercially available alkyl dimethyl benzyl ammonium compounds are blends of C12, C14, and C16 alkyl dimethyl benzyl ammonium chlorides. Generally, it is preferable that the alkyl dimethyl benzyl ammonium compound, when a blend, contains higher concentrations of C12 alkyl and C14 alkyl components than C16 alkyl components. It is noted that other anions, including those mentioned above, may also be used.

In still another embodiment, the quaternary ammonium may comprise a quaternary ammonium propionate. The quaternary ammonium propionate, for instance, may comprise a poly(oxyalkyl)ammonium propionate. In one particular embodiment, for instance, the first biocide may comprise N,N-didecyl-N-methyl-poly(oxyethyl)ammonium propionate.

One particular quaternary ammonium compounds included carbonate/bicarbonate salt of a quaternary ammonium cation. A quaternary ammonium carbonate can be represented by the following formula:

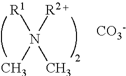

wherein R¹ is a C₁-C₂₀ alkyl or aryl-substituted alkyl group and R² is a C₈-C₂₀ alkyl group, and preferably wherein R¹ is the same as R² and R¹ is a C₈-C₁₂ alkyl group, as well as compositions further comprising the corresponding quaternary ammonium bicarbonate

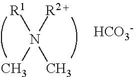

wherein R¹ is the same or a different C₁-C₂₀ alkyl or aryl-substituted alkyl group as above and R² is the same or a different C₈-C₂₀ alkyl group as above, but preferably wherein R¹ is the same as R² and R¹ is a C₈-C₁₂ alkyl group.

In one embodiment, the first biocide contained in the composition comprises a di C₈-C₁₂ alkyl ammonium carbonate/bicarbonate. For example, in one particular embodiment, the antimicrobial or preservative composition contains didecyl dimethyl ammonium carbonate and didecyl dimethyl ammonium bicarbonate.

In other embodiments, however, the carbonate/bicarbonate salts of quaternary ammonium cations may be selected from dioctyldimethylammonium carbonate, decyloctyldimethylammonium carbonate, benzalkonium carbonate, benzethonium carbonate, stearalkonium carbonate, cetrimonium carbonate, behentrimonium carbonate, dioctyldimethylammonium bicarbonate, decyloctyldimethylammonium bicarbonate, benzalkonium bicarbonate, benzethonium bicarbonate, stearalkonium bicarbonate, cetrimonium bicarbonate, behentrimonium bicarbonate, and mixtures of one or more such carbonate salts.

In addition to the quaternary ammonium compounds listed above, other compounds and, oligomers and polymeric material have one or more quaternary ammonium groups may also be use as the biocidal agent. One such example are “Gemini” quats, also known as di-quaternary ammonium compounds which have two quaternary ammonium groups linked together by a linking group. Example of Gemini quats include, for example, quaternary ammonium compounds of the general formula:

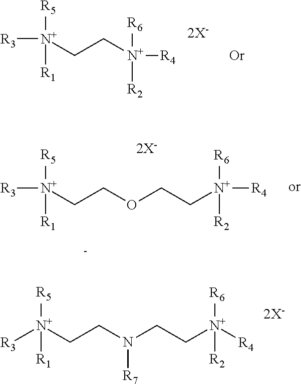

Where R₁, R₂, R₃, R₄, R₅, R₆ and R₇ can vary within wide limits and examples of quaternary ammonium compounds that have anti-microbial properties will be well known to the person of ordinary skill in the art. Typically, two of R₁, R₃, R₅ and two of R₂, R₄ and R₆ are lower alkyl, meaning having 1 to 4 carbon atoms, such as methyl, ethyl, propyl or butyl groups. In addition, at least one of R₁, R₃, R₅ and at least one of R₂, R₄ and R₆ is longer chain alkyl groups of 6 to 24 carbon atoms, or a benzyl group. X⁻ is a monovalent anion or one equivalent of a polyvalent anion of an inorganic or organic acid. Suitable anions for X⁻ or M⁻ are in principle all inorganic or organic anions, in particular halides, for example chloride or bromide, carboxylates, sulfonates, phosphates, carbonate, a bicarbonate/carbonate or a mixture thereof. An exemplary Gemini Quat is bis (2-N,N-dimethyl-N-alkyl ammonium ethylether) dichloride

In another embodiment, the biocidal agent may comprise an amine. Amines, for instance, have been found to have a synergistic interaction with a quaternary ammonium carbonate when controlling the growth of bacteria, particularly gram negative bacteria. Suitable amines include, but are not limited to, tertiary amines, such as (C8-C14) alkyl amines. The term “(C8-C14) alkyl amine” encompasses all amines which contain a (C1-C14) alkyl group. One (C8-C14) alkyl amine is N,N-bis(3-aminopropyl)dodecylamine, available as Lonzabac® 12.30 and 12.100 from Lonza, Inc.

Other exemplary tertiary amines include, for example, N-(3-aminopropyl)-N-dodecyl-1,3 propane-diamine, N-(3-aminopropyl)-N-decyl-1,3-propanediamine, N-(3-aminopropyl)-N-tetradecyl-1,3-propanediamine, N-(3-aminopropyl)-N-octyl-1,3-propanediamine, N-(3-aminopropyl)-N-hexadecyl-1,3-propanediamine; as well as their acid addition compounds. Other similar tertiary amines may be used.

In one embodiment, the biocidal agent may comprise a guanidine, and particularly a biguanide and/or its substitution products, salts, analogs, derivatives, and/or combinations thereof. Biguanide is commonly represented by the following formula, though it is known to exist in other forms.

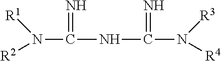

wherein R¹, R², R³ and R⁴ are each independently chosen from hydrogen, optionally substituted alkyl, optionally substituted phenyl, ethylene glycol, diethylene glycol, methylene glycol and tetraethylene glycol, or one of R¹, R², R³ and R⁴ may be

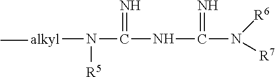

where R⁵, R⁶ and R⁷ are each independently chosen from hydrogen, optionally substituted alkyl, optionally substituted phenyl, ethylene glycol, diethylene glycol, methylene glycol and tetraethylene glycol. Substituents for the alkyl and phenyl groups include but are not limited to halo, e.g. chloro, bromo, fluoro or iodo, hydroxy and amino. The alkyl groups may have from 1 to 6 carbons, and may be saturated or unsaturated, straight chain or branched.

In one embodiment, the biocidal agent may comprise a polymeric biguanide, otherwise known as a polybiguanide, or a salt, analog, or derivative thereof. In one embodiment, the polybiguanide may be a copolymer or a heteropolymer. The polybiguanide may be linear, branched, circular, and/or dendrimeric. The number of polymer repeating units can vary from 2 to 1,000, such as from 5 to 750, such as from 10 to 500, such as from 25 to 250, such as from 50 to 100 repeating units. In one specific embodiment, the polybiguanide may comprise polyhexamethylene biguanide (PHMB), polyhexamethylene monoguanide (PHMG), polyethylene biguanide (PEB), polytetramethylene biguanide (PTMB), polyethylene hexamethylene biguanide (PHMB), polymethylene biguanides (PMBs), poly(allylbiguanidnio-co-allyamine, poly(N-vinyl-biguanide), polyallylbiguanide etc.

For example, in one particular embodiment, the biocidal agent may comprise a polyalkylene biguanide, such as polyhexamethylene biguanide. In one embodiment, the biocidal agent may comprise polyhexamethylene biguanide hydrochloride (PHMB), also known as polyaminopropyl biguanide (PABP). [0035] PHMB is commonly represented by the following formula, though it is known to exist as a complex mixture of polymeric biguanides with various terminal groups including guanidine (not shown).

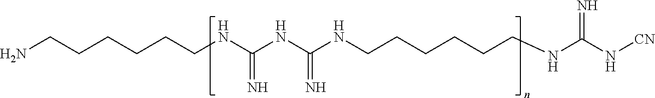

The value n represents the number of repeating units of the biguanide polymer.

More particularly, PHMB can be a mixture of various biguanide polymers that can include different combinations of terminal groups, e.g., amine, cyanoguanidino, and guanidine. Based only on these three terminal groups, at least six possible biguanide polymers can exist. There can be one biguanide polymer with two terminal amine groups, which is referred to as PHMB-AA, one with two terminal cyanoguanidino groups, which is referred to as PHMB-CGCG, and one with two terminal guanidine groups, which is referred to as PHMB-GG (see, below). There are also the three possible biguanide polymers having a combination of two different terminal groups. Again, based on the above terminal groups they include amine-cyanoguanidino (PHMB-ACG), amine-guanidino (PHMB-AG) and guanidine-cyanoguanidino (GCG). Accordingly, a sample of PHMB may comprise a mixture of polymeric biguanides with the three mentioned terminal groups. Moreover, some of the composition can include in-chain polymeric guanide (not shown). The subscript “n” represents the average number of repeating groups, and a distribution of polymer length exists for each of the polymers shown below.

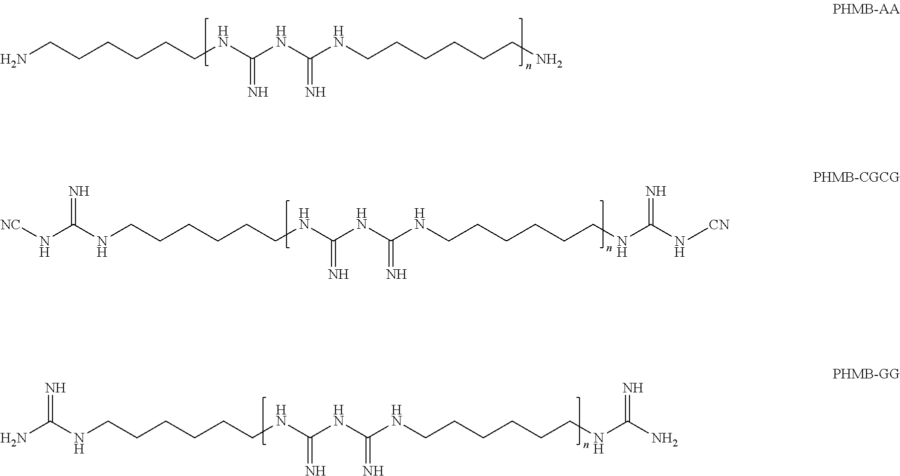

wherein n can be from about 1 to about 50, such as from about 1 to about 20.

Polyhexamethylene biguanide, such as polyhexamethylene biguanide hydrochloride, has a broad antimicrobial range and is fast acting. Further, the antimicrobial agent is stable over a broad pH range.

In one embodiment, the biocidal agent may comprise a bis-biguanide. Bis-biguanide is commonly represented by the following formula, though it is known to exist in other forms.

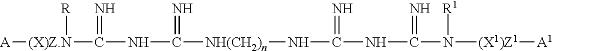

wherein A and A¹ each represent either (1) a phenyl radical which optionally is substituted by an alkyl or alkoxy group containing from 1 to about 4 carbon atoms, a nitro group, or a halogen atom; (2) an alkyl group containing from 1 to about 12 carbon atoms; or (3) alicyclic groups containing from 4 to about 12 carbon atoms; wherein X and X¹ each represent an alkylene radical containing from 1 to 3 carbon atoms; wherein Z and Z¹ each can be either 0 or 1; wherein R and R¹ each represent either hydrogen, or alkyl radical containing from 1 to about 12 carbon atoms, or an aralkyl radical containing from 7 to about 12 carbon atoms; wherein n is an integer from 2 to 12 inclusive; and wherein the chain (CH₂)ₙ may optionally be interrupted by oxygen or sulfur atoms, aromatic nuclei, etc. or substituted with halide, hydroxyl, alkyl, alkenyl, alkynl, or acetyl groups, aromatic nuclei, etc. In one embodiment, the chain (CH₂)ₙ may optionally be replaced by a bivalent bridging group, wherein the bivalent bridging group may be chosen from but is not limited to alkylenes, alicyclic groups, cyclic nuclei, aromatic nuclei etc. which may be substituted with or interrupted by oxygen or sulfur atoms, aromatic nuclei, etc. Exemplary bis-biguanide compounds include but are not limited to chlorhexidine, alexidine, trifluoromethyl phenyl bis-biguanide, analogs, derivatives, and/or salts thereof.

In one particular embodiment, the biocidal agent may comprise chlorhexidine or derivatives or salts thereof. Chlorhexidine is commonly represented by the following formula.

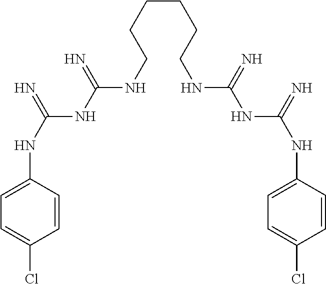 [SMILES: N=C(NCCCCCCNC(=N)NC(=N)Nc1ccc(Cl)cc1)NC(=N)Nc1ccc(Cl)cc1]

In one embodiment the biocidal agent may comprise a chlorhexidine salt. For example, the biocidal agent may comprise chlorhexidine gluconate, chlorhexidine hydrochloride, or chlorhexidine acetate.

In one embodiment, the biocidal agent may comprise a biguanide salt. For instance, in one embodiment the biocidal agent may comprise inorganic or organic salts of biguanide, polybiguanide, bisbiguanide, derivatives, and/or analogs thereof. In one particular embodiment the biocidal agent may comprise biguanide, polybiguanide, and/or bis-biguanide halides; including chlorides, bromides, and iodides; hydrochlorides; sulfates; gluconates; acetates; oxalates; succinates; tartrates; phosphites; phosphates; phosphonates; nitrites; nitrates; carbonates; sulfates; sulfonates; alkyl sulfonates; phenyl sulfonates; amino carboxylates; carboxylates; hydroxy carboxylates; organophosphates; organophosphonates; organosulfonates; organosulfates etc. and combinations thereof.

In another embodiment, the biocidal agent may comprise a metal complex of biguanide. In one embodiment, for example, the biocidal agent may be chosen from but is not limited to the group comprising biguanide, derivatives, and/or analogs thereof com plexed with iron, zinc, nickel, chromium, cadmium, ruthenium, iridium, mendelevium, silver, osmium, silicone, platinum, manganese, cobalt, copper, boron, technetium, rhenium, palladium, vanadyl etc., and combinations thereof.

In one embodiment, the biocidal agent may comprise a biguanide chosen from the group comprising dimethoxyphenyl biguanide, arylbiguanides, N-arylated biguanides, N-alkylated biguanides, N,N-disubstituted biguanides, dimethyl-biguanide (metformin), N-(4-chlorophenyl)-N′-(isopropyl)-imidodicarbonimidic diamide (proguanil), 1-[amino-(3,4-dichloroanilino)methylidene]-2-propan-2-ylguanidine (chlor-proguanil), 1-butylbiguanide (buformin), phenethyl biguanide (phenformin), pyrimethamine, phenanthridine biguanides, arylmethylbiguanide, and chlorophenylbiguanide etc.

Another biocidal agent useable in the present disclosure includes phenolic compounds. One particular phenolic compound is Parachlorometaxylenol (“PCMX”). PCMX is effective against both gram-positive and gram-negative bacteria. PCMX is sometimes referred to by its other names, including: chloroxylenol; 4-chloro-3,5 xylenol; 4-chloro-3,5-dimethylphenol; 2-chloro-m-xylenol; 2-chloro-5-hydroxy-m-xylene; 2-chloro-5-hydroxy-m-xylene; 2-chloro-5-hydroxy-1,3-dimethylbenzene; 4-chlor-1-hydroxy-3,5-dimethyl benzene; and 3,5-dimethyl-4-chlorophenol. Typical amounts of upto about 3% by weight of the disinfectant composition.

Another biocidal agent useable in the present disclosure includes alcohol compounds. The alcohol is typically selected among mono-functional low-molecular alcohols, preferably alkanols with one to four carbon atoms such as methanol, ethanol, isopropanol or butanol, or combinations thereof. A particularly suitable alcohols include ethanol and isopropyl alcohol.

The biocidal agent may also be an organic acid compound. Organic acids may be at least one monocarboxylic or polycarboxylic organic acid. Such may be any monocarboxylic acid, or polycarboxylic acid, whether saturated or unsaturated, that is soluble in water. The organic acid constituent may be a compound having the formula: R—COOH wherein R is hydrogen, lower alkyl; substituted lower alkyl; hydroxy lower alkyl; carboxy lower alkyl; carboxy, hydroxy lower alkyl; carboxy, halo lower alkyl; carboxy, dihydroxy lower alkyl; dicarboxy, hydroxy lower alkyl; carboxy lower alkenyl; dicarboxy lower alkenyl; phenyl; substituted phenyl, wherein substituted lower alkyl is substituted by one or more groups consisting of halogen, hydroxyl, amino, thiol, nitro, and cyano. Representative examples of such acids are monocarboxylic acids such as formic acid, acetic acid, chloroacetic acid, lactic acid, ascorbic acid salicylic acid; dicarboxylic acids such as fumaric acid, malonic acid, succinic acid, glutaric acid, itaconic acid, tartaric acid; tricarboxylic acids such as citric acid; said acids may be used singly or as admixtures thereof.

Another biocidal agent useable in the present disclosure includes peroxide a compounds. Exemplary peroxides include, for example, hydrogen peroxide sources to be used in the invention, include but are not limited to, aqueous hydrogen peroxide solution, sodium percarbonate, potassium percarbonate, sodium and potassium perborate, hydrogen peroxide urea, as well as their hydrated forms, and mixtures thereof. In one embodiment, the hydrogen peroxide source is an aqueous solution containing about 0.5% to about 50% by weight hydrogen peroxide dissolved in water. In another embodiment, the hydrogen peroxide source may be a solid formulation of sodium percarbonate.

In addition to hydrogen peroxide disinfectants, peracidss disinfectants may be used. As used herein, the terms “peracid” or “peroxy acid” refer to an acid having the hydrogen of the hydroxyl group replaced by a hydroxy group. Oxidizing peracids are referred to herein as peroxycarboxylic acids. Conventional peroxycarboxylic acid compositions are formed through an acid catalyzed equilibrium reaction. Although acid catalyzed equilibrium reactions are commonly used to generate peroxycarboxylic acids. Peroxycarboxylic (or percarboxylic) acids generally have the formula R(CO3H)n, where, for example, R is an alkyl, aryl alkyl, cycloalkyl, aromatic, or heterocyclic group, and n is one, two, or three, and named by prefixing the parent acid with peroxy. The R group can be saturated or unsaturated as well as substituted or unsubstituted.

Further example of disinfecting agents include iron chelators, bispyridine compounds and iodine compounds. Exemplary iron chelators include compounds such as pyrithione compounds and compounds such as piroctone olamine or hydroxyl pyridine compounds and salts thereof. Pyrithione is known by several names, including 2 mercaptopyridine-N-oxide; 2-pyridinethiol-1-oxide (CAS Registry No. 1 121-31-9). Other iron chelators include, for example, 1-hydroxypyridine-2-thione and 1 hydroxy-2(1H)-pyridinethione (CAS Registry No. 1 121-30-8); 2-pyridinol-1-oxide (HPNO) and N-hydroxy-6-octyloxypyridine 2(1H)-one and -hydroxy-6-octyloxypyridine 2(1H)-one ethanolamine salt (. Pyrithione salts are commercially available from Lonza, Inc., such as Sodium OMADINE© or Zinc OMADINE© pyridinol compounds, for example, 2-pyridinol-1-oxide (HPNO). Bispyridine compounds include compound such as octenidine. Iodine compounds include compounds such as povidone-iodine.

In addition, the biocidal agent may be a single biocidal agent, an mixture of tor or more biocidal agents from a single type of biocidal agent or may be a mixture of two or more different types of biocidal agents. For example, the biocidal agent may be a mixture of different quaternary ammonium compounds, a mixture of a quaternary ammonium compound with and amine, a mixture of a quaternary ammonium compound with a biguanide, and other similar mixtures.

In an embodiment, polyglycerol esters useable in the present disclosure may be formed from saturated, unsaturated, natural or synthetic fatty acids, and the like. For instance, saturated fatty acids include caprylic acid, capric acid, lauric acid, myristic acid, palmitic acid, stearic acid, arachidic acid, behenic acid, lignoceric acid, cerotic acid, combinations thereof, derivatives thereof, and the like. Furthermore, the polyglycerol esters are derived from (a) a polyglycerol component built up from 2 to 12 molecules of glycerol, based on an average, and (b) a fatty acid selected from the group consisting of caprylic acid, capric acid, lauric acid, myristic acid, palmitic acid, stearic acid, arachidic acid, behenic acid, lignoceric acid, cerotic acid, oleic acid, decaoleic acid, mixtures thereof and the like.

Examples of polyglycerol esters useable in the present disclosure, include but are not limited to, polyglyceryl monodecaoleate such as polyglyceryl-10 decaoleate; polyglyceryl monooleate such as polyglyceryl-2-monooleate, polyglyceryl-3 monooleate, polyglyceryl-4 monooleate, polyglyceryl-6 monooleate, or polyglyceryl-10 monooleate; polyglyceryl dioleate such as polyglyceryl-2 dioleate, polyglyceryl-3 dioleate, polyglyceryl-5 dioleate, polyglyceryl-6 dioleate or polyglyceryl-10 dioleate; polyglyceryl trioleate such as polyglyceryl-5 trioleate or polyglyceryl-10 trioleate; polyglyceryl tetraoleate such as polyglyceryl-2 tetraoleate, polyglyceryl-6 tetraoleate, or polyglyceryl-10 tetraoleate; polyglyceryl pentaoleate such as polyglyceryl-4 pentaoleate, polyglyceryl-6 pentaoleate, or polyglyceryl-10 pentaoleate; polyglyceryl heptaoleate such as polyglyceryl-6 heptaoleate, polyglyceryl-10 heptaoleate; polyglyceryl monostearate such as polyglyceryl-2 monostearate, polyglyceryl-3 monostearate, polyglyceryl-4 monostearate, polyglyceryl-5 monostearate, polyglyceryl-6 monostearate or polyglyceryl-10 monostearate; polyglyceryl distearate such as polyglyceryl-2 distearate, polyglyceryl-3 distearate, polyglyceryl-4 distearate, polyglyceryl-6 distearate, or polyglyceryl-10 distearate; polyglyceryl tristearate such as polyglyceryl-4 tristearate, polyglyceryl-5 tristearate, polyglyceryl-6 tristearate, or polyglyceryl-10 tristearate; polyglyceryl tetrastea rate such as polyglyceryl-2 tetrastearate; polyglyceryl pentastearate such as polyglyceryl-4 pentastearate, polyglyceryl-6 pentastearate, or polyglyceryl-10 pentastearate; polyglyceryl heptastearate such as polyglyceryl-10 heptastearate; polyglyceryl isostearate such as polyglyceryl-2 isostearate, polyglyceryl-3 isostearate, polyglyceryl-4 isostearate, polyglyceryl-6 isostearate, or polyglyceryl-10 isostearate; polyglyceryl diisostearate such as polyglyceryl-2 diisostearate. polyglyceryl-3 diisostearate, polyglyceryl-4 diisostearate, polyglyceryl-6 diisostearate, polyglyceryl-10 diisostearate, or polyglyceryl-15 diisostearate; polyglyceryl triisostearate such as polyglyceryl-2 triisostearate, polyglyceryl-3 triisostearate, polyglyceryl-5 triisostearate, polyglyceryl-10 triisostearate; polyglyceryl tetraisostearate such as polyglyceryl-2 tetraisostearate; polyglyceryl caprylate such as polyglyceryl-2 caprylate, polyglyceryl-3 caprylate, polyglyceryl-4 caprylate, polyglyceryl-6 caprylate, or polyglyceryl-10 caprylate; polyglyceryl dicaprylate such as polyglyceryl-5 dicaprylate; polyglyceryl sesquicaprylate such as polyglyceryl-2 sesquicapyrlate; polyglyceryl octacaprylate such as polyglyceryl-6 octacaprylate; polyglyceryl caprate such as polyglyceryl-2 caprate, polyglyceryl-3 caprate, polyglyceryl-4 caprate, polyglyceryl-5 caprate, polyglyceryl-6 caprate, polyglyceryl-10 caprate, polyglyceryl dicaprate such as polyglyceryl-3 dicaprate or polyglyceryl-6 dicaprate; polyglyceryl caprylate/caprate such as polyglyceryl-4 capyrlateicaprate, polyglyceryl-6 caprylate/caprate, or polyglyceryl-10 caprylate/caprate; polyglyceryl palmitate such as polyglyceryl-2 palmitate, polyglyceryl-3 palmitate, polyglyceryl-6 palmitate or polyglyceryl-10 palmitate; polyglyceryl dipalmitate such as polyglyceryl-6 dipalmitate or polyglyceryl-10 dipalmitate; polyglyceryl tetrabehenate such as polyglyceryl-6 tetrabehenate; polyglyceryl myristate such as polyglyceryl-6 myristate or polyglyceryl-10 myristate; polyglyceryl rincinoleate such polyglyceryl-6 polyricinoleate or polyglyceryl-10 ricinoleate; or mixtures thereof, other complexes or derivatives thereof, and the like.

Suitably, the polyglycerol ester may be one or more of a polyglyceryl-10 decaoleate, polyglyceryl-3 monostearate, polyglyceryl-6 distearate, polyglyceryl-10 stearate, polyglyceryl-10 oleate, polyglyceryl-10 dipalmitate, polyglyceryl-10 caprylate/caprate; and a mixture thereof. In one aspect, the polyglycerol ester is polyglyceryl-10 caprylate/caprate.

In the present disclosure, the weight ratio of the polyglycerol ester (PGE) to the biocidal agent (BA) is typically in the range of about 0.00001 to about 10.0 (PGE/BA). As used herein, the “weight ratio” is calculated by dividing the amount of polyglycerol ester by the amount of biocidal agent (e.g. a weight ratio of 10 is the same as 10 PGE:1 BA). More typically, the weight ratio of the polyglycerol ester (PGE) to the biocidal agent (BA) is typically in the range of about 0.0001 to about 2.0, more typically in the range of 0.001 to 1.5 and ever more particularly 0.01 to 1.0. The weight ratio of the PGE to BA may be in any amount between the minimum and the maximum. For Example, the ratio may be between 0.00001 to 2.0; 0.0001 to 1.5; 0.00001 to 1; 0.00001 to 0.5; 0.0001 to 10; 0.0001 to 1.5; 0.0001 to 1; 0.0001 to 0.5; 0.001 to 10; 0.001 to 1.5; 0.001 to 1; 0.001 to 0.5; 0.01 to 10; 0.01 to 1.5; 0.01 to 1; 0.01 to 0.5.

The amount of the biocidal agents used in the disinfectant composition of the present disclosure are used in varying amounts depending on the biocidal agents. For example, quats, bigunides and amines are typically used in amounts less than 5% by weight in the final use formulation. By “final use formulation” it is intended the formulation when used as a disinfectant. Other biocidal agents, such as the alcohols, may be present in the final use formulation in amounts up to 50% by weight or more, depending on the intended final use formulation. Depending on the actual biocidal agent, the maximum amount of a particular agent is governed by regulations that vary country to country and region to region.

When the biocidal agent is a quaternary ammonium compound, an amine, a biguanide or mixture thereof, the final use formulation will generally contain from about 10 ppm (parts per million) to about 10000 ppm total content of the biocidal agent. For example, the biocidal agent will typically be present in an amount of about 50 ppm to 5000 ppm, more typically in an amount of 100 ppm to 3000 ppm in the final use formulation.

In an alternative embodiment, the disinfectant may be in the form of a disinfectant concentrate. By “disinfectant concentrate” it is meant a composition which may be diluted with solvent prior to use. In the disinfectant concentrate, the amount of the biocidal agent will be higher than typical final use amounts. To save space and shipping cost, the disinfectant is typically provided as a disinfectant concentrate. Dilution of the disinfectant concentrate will typically be with an aqueous solvent prior to use. One particular aqueous solvent which can be used is water. Dilution can be any amount of the solvent needed to get the concentrate diluted to a desired level of active ingredient for its intended use. Is typically such that the set amount of the concentrated is added to a specified amount of the solvent. For example, one ounce of the concentrate can be added to a pint of solvent for a 1:16 dilution rate; one ounce of concentrate can be added to a quart of a solvent for a 1:32 dilution rate, one ounce of concentrate can be added to % gallon of solvent for a 1:64 dilution rate; one ounce of concentrate can be added to one gallon of water for a 1:128 dilution rate and so one. Likewise metric dilution rates could also be used, for example 10 ml per liter for a 1:100 dilution rate, and the like.

When contained in a disinfectant product, the biocidal agent and the polyglycerol ester may be combined with various different components. For instance, in one embodiment, a solvent can be present in the product. Generally, the solvent will be a polar solvent such as water, or a water-miscible solvent, such as an alcohol and/or a glycol ether. In addition to water, the anti-microbial composition can further include a water-miscible organic solvent. Examples of water-miscible solvents include ethanol, propanol, benzyl alcohol, phenoxyethanol, isopropanol, diethylene glycol propyl ether, ethylene glycol monomethyl ether, ethylene glycol monoethyl ether, ethylene glycol monopropyl ether, ethylene glycol monoisopropyl ether, ethylene glycol monobutyl ether, diethylene glycol monomethyl ether, diethylene glycol monobutyl ether, diethylene glycol monoethyl ether, diethylene glycol mono-n-butyl ether, ethylene glycol dimethyl ether, ethylene glycol diethyl ether, ethylene glycol dibutyl ether, propylene glycol n-butyl ether, tripropylene glycol methyl ether, dipropylene glycol methyl ether, dipropylene glycol butyl ether and combinations thereof.

In addition to a solvent, the disinfectant product may contain a surfactant. Typically, the surfactant will be a nonionic surfactant or a cationic surfactant. The surfactant is present in an amount between about 1% to about 20% by weight of the disinfectant concentrate. Typically, the surfactant will be between 2% and 15% by weight of the concentrate.

Particularly suitable surfactants are alkoxylated alcohol surfactant will generally have between about 2 to about 8 moles of alkoxylation. Typically, there will be between 3 and 6 moles of alkoxylation. One particular example is about 4.5 moles of alkoxylation. In addition to having the degree of alkoxylation, the alcohol which is alkoxylate will be a C4-C12 alkyl alcohol. In one embodiment, the alkyl alcohol is a C8-C10 alkyl alcohol. The alkoxylation may be ethoxylation. Generally, it is desirable to have the HLB (hydrophilic-lipophilic balance) to be in the range of 8-14, and more generally between 10 and 12, for example about 11.

The non-ionic surfactants that may be used in the invention include, but are not limited to, polyoxyethylene glycol alkyl ethers, octaethylene glycol monododecyl ether, pentaethylene glycol monododecyl ether, polyoxypropylene glycol alkyl ethers, glucoside alkyl ethers, decyl glucoside, lauryl glucoside, octyl glucoside, polyoxyethylene glycol octylphenol ethers, polyoxyethylene glycol alkylphenol ethers, glycerol alkyl esters, glyceryl laurate, polyoxyethylene glycol sorbitan alkyl esters, sorbitan alkyl esters, dodecyldimethylamine oxide, block copolymers of polyethylene glycol and polypropylene glycol, poloxamers and polyethoxylated tallow amine (POEA), and mixtures thereof. The amount of the nonionic surfactant in the concentrate is from about 1 to about 8% w/w % of the formulation. Typically, the concentrate contains from 2 to 5 w/w % of nonionic surfactant. The amount of the nonionic surfactant in the ready-to-use product is from about 0.05 to about 3 w/w % of the solution. In another embodiment, the nonionic surfactant in the product is from about 0.05 to about 1 0.5 w/w % of the solution. Typically, the disinfectant product contains from 0.06 to 1 w/w % of the nonionic surfactant.

Additionally, the disinfectant product may contain an optional sequestering agent. Sequestering agents include, for example, acetic acid derivative selected from the group consisting of ethylenediaminetetraacetic acid (EDTA), nitrilotriacetic acid (NTA), tetrasodium EDTA. The ability of NTA and EDTA to remove metal ions facilitates of the solution by preventing hardness (calcium) precipitation. The sequestering agent may also serve to bind other metal ions that may adversely affect the effectiveness of the disinfecting components in the composition. In addition, sequestering agent may also assist in soil removal and/or preventing soil redeposition into the disinfecting composition while in use. The sequestering agents, when present in the concentrate is generally present in an amount up to about 20% by weight, and are typically present in an amount of about 2 to about 8% by weight.

The disinfectant product may also contain a pH adjusting agent. Suitable pH adjusting agents include sodium hydroxide, sodium citrate and other similar compounds. In the present invention, the concentrate and the final disinfectant composition will have a pH in the range of about 6 to about 13. Generally the disinfectant composition will be considered a neutral disinfecting composition if the pH is in the range of about 6 to about 8. The disinfectant composition will be considered an alkaline disinfectant composition when the pH is in the range of above 8 to about 12.

The disinfectant composition may optionally further contain corrosion inhibitors, complexing agents, auxiliaries, preservatives, fragrances, colorants and the like. Exemplary corrosion inhibitors include, for example, organic phosphorous compounds and blend of organic phosphorous compounds with a polymeric component. Exemplary auxiliaries include, for example, polyethylene glycol or other similar compounds. Colorants and fragrances may be added provided they do not interfere with the function of the composition and may serve for identifying the composition. Generally, the optional further ingredients will make up less than about 20% by weight of the composition.

The disinfectant composition may also comprise at least one acid or salt thereof. The acid may be an inorganic acid or an organic acid. In a preferred embodiment the acid is a C1 to C8 carboxylic acid. In a particular embodiment, the acid is a monocarboxylic acid, a dicarboxylic acid, a tricarboxylic acid, or a mixture thereof. In an additional embodiment, the acid is a hydroxyl acid, an aromatic acid, or a mixture thereof. In another additional embodiment, the acid is methanesulfonic acid, phosphoric acid, etidronic acid, phytic acid, phosphoacetic acid, N-(phosphonomethyl)iminodiacetic acid, diethylenetriaminepentakis(methylphosphonoic acid), S,S-ethylenediamine-N′N′-disuccinic acid, their alkaline salts, or any mixture thereof.

In some embodiments, the acid is citric acid, phosphoric acid, succinic acid, lactic acid, S,S-ethylenediamine-N,N′-disuccinic acid, 1-hydroxyethane 1,1-diphosphonic acid (HEDP), dipicolinic acid (DPA), methanesulfonic acid (MSA), their alkaline salts, or any mixture thereof.

In one embodiment, the acid is a mixture of acids. In some embodiments, the acid comprises one or more of the following organic acids: citric acid, succinic acid, phosphoric acid, and lactic acid. In another embodiment, the acid comprises one or more of the following acids: citric acid, succinic acid, phosphoric acid, and lactic acid, in combination with another acid. For example, citric acid may be used in combination with ethylenediamine-N,N′-disuccinic acid or its alkaline salt, HEDP, and/or MSA. As another example, succinic acid may be used in combination with ethylenediamine-N,N′-disuccinic acid or its alkaline salt, HEDP, and/or MSA. As another example, phosphoric acid may be used in combination with ethylenediamine-N,N′-disuccinic acid or its alkaline salt, HEDP, and/or MSA. As another example, lactic acid may be used in combination with ethylenediamine-N,N′-disuccinic acid or its alkaline salt, HEDP, and/or MSA.

The disinfectant composition may include from about 1% by weight to about 5% by weight of an organic acid such as citric acid, succinic acid, phosphoric acid, lactic acid, or any mixture thereof, in combination with another acid. In another aspect, the composition may include from about 1% by weight to about 5% by weight of an organic acid such as citric acid, succinic acid, phosphoric acid, lactic acid, or any mixture thereof, in combination with from about 0.05% by weight to about 5% by weight of another acid. In another embodiment, the composition may include from about 2% by weight to about 4% by weight of an organic acid such as citric acid, succinic acid, phosphoric acid, lactic acid, or any mixture thereof, in combination with from about 0.1% by weight to about 4% by weight of another acid such as ethylenediamine-N,N′-disuccinic acid or its alkaline salt, HEDP, and/or MSA.

Disinfectant Applications

Various different disinfectant compositions can be made in accordance with the present disclosure. The disinfectant product may be used, for instance, to clean hard surfaces, to pre-clean sterilize or high-level disinfect instruments, and/or as a hand sanitizer. In general, the biocidal can be incorporated into any suitable disinfectant product.

When used as a hard surface cleaner, the disinfectant composition can be delivered to a surface to be cleaned, sanitized or disinfected by conventional means such as pouring the composition on a surface; a spray; which is applied to a surface via a spray means, including but not limited to, pump spray applicators, pressurized spray applicators and the like; a saturated wipe; a rag and a bucket; a mop and bucket; a sponge and a bucket; or via automated cleaning equipment and other similar and conventional ways to apply an anti-microbial composition to a surface for the purposes of sanitizing or disinfecting the surface.

To use the disinfectant composition of the present disclosure, a surface is treated with the substrate by spraying, pouring, wiping or otherwise applying the anti-microbial composition to the surface. Once applied to the surface, the anti-microbial composition is allowed to remain on the surface for a period of time. The anti-microbial composition may be applied to the surface and allowed to dry or may alternatively be dried by wiping the surface with a dry wipe or wiping device.

Surfaces, which may be disinfected with the compositions include, but are not limited to, those located in dairies, homes, health care facilities, swimming pools, canneries, food processing plants, restaurants, hospitals, institutions, and industry, including secondary oil recovery. Hard surfaces, such as glass and polished aluminum, are particularly suited for application. Specific areas targeted for application include hard surfaces in the home such as kitchen countertops, cabinets, appliances, waste cans, laundry areas, garbage pails, bathroom fixtures, toilets, water tanks, faucets, mirrors, vanities, tubs, and showers. The compositions can also be used to sanitize floors, walls, furniture, mirrors, toilet fixtures, windows, and wood surfaces, such as fence rails, porch rails, decks, roofing, siding, window frames, and door frames. The compositions, quaternary ammonium chloride compound, and disinfecting active are particularly well suited for application on indirect food contact surfaces, such as cutting boards, utensils, containers, dishes, wash basins, appliances, and countertops. The compositions or quaternary ammonium chloride compound can be used to sanitize dairy plant equipment, milking machines, milk pails, tank trucks, and the like. Areas in hospitals would include beds, gurneys, tables, canisters, toilets, waste cans, stands, cabinets, shower stalls, floors, walls or any other non-porous surface.

One particularly useful application method is to impregnate the disinfectant composition into a wipe substrate. In this embodiment, the wipe is a single use wipe that is impregnated with the disinfecting composition and is stored in a container that will dispense the wipe to a user. The container with the wipes may contain a single wipe, or several wipes. Suitable containers include a pouch containing a single wipe, such as a moist towelette which is torn open by the user, or may be a pouch with a resealable opening containing several wipes in a stacked fashion, a rolled fashion or other suitable formation that would allow a single wipe to be removed from the opening at a time. Pouches are generally prepared form a fluid impervious material, such as a film, a coated paper or foil or other similar fluid impervious materials. In another way to dispense wipes of the present invention is to place the wipe in to a fluid impervious container having an opening to access the wipes in the container. Containers may be molded plastic container with lids that are fluid impervious. Generally, the lid will have an opening to access the wipes in the container. The wipe in the container may be in a interleaved stacked, such that as a wipe is removed from the container the next wipe is positioned in the opening of the container ready for the user to remove the next wipe. Alternatively, the wipe may be a continuous material which is perforated between the individual wipes of the continuous material. The continuous wipe material with perforations may be in a folded form or may be in a rolled form. Generally, in the rolled form, the wipe material is feed from the center of the rolled material. As with the interleaved stack, as a wipe is removed from the container, the next wipe is positioned in the opening for the use to remove the next wipe, when needed.

Disposable wipes provide advantages over other application vehicles, such as a reusable sponge, rag or the like. Unlike sponges, rags and the like, which are used repeatedly, the impregnated wipe is used a single time and disposed of. As is mentioned above, reused sponge or rag presents problems since the sponge or rags may carry microbes that are not easily killed by the disinfecting composition. Further, the disinfecting composition is formulated to treat hard surface, not porous soft surfaces that are present in sponges or rags.

The disinfecting composition can be impregnated into the wipe such that the wipe is pre-moistened and will express or release the disinfecting composition on to the surface as the wipe is run across the surface to be treated. Generally, the disinfecting composition is saturated into the wipe such that the wipe will release the disinfecting composition to the surface through the wiping action.

Depending on the wipe substrate, saturation was generally achieved using about 3 wt parts of the use disinfecting composition per 1 wt part of the wipe substrate to be saturated. Generally, the disinfecting composition is used from about 4 parts to 6 parts by weight per 1 part by of the wiper substrate. In these ranges, complete saturation of the substrates can be achieved. It is noted that the amount of the disinfecting solution may go up or down to achieve complete saturation of the wipe substrate, depending on the particular wipe substrate.

Suitable wipe substrates include woven and nonwoven materials. Essentially any nonwoven web material may be used. Exemplary nonwoven materials may include, but are not limited to meltblown, coform, spunbond, airlaid, hydroentangled nonwovens, spunlace, bonded carded webs, and laminates thereof. Optionally, the nonwoven may be laminated with a film material as well. The fibers used to prepare the wipe substrate may be cellulosic fiber, thermoplastic fibers and mixtures thereof. The fibers may also be continuous fibers, discontinuous fibers, staple fibers and mixtures thereof. Basis weights of the nonwoven web may vary from about 12 grams per square meter to 200 grams per square meter or more.

In one embodiment the wipe is impregnated with a liquid component containing both active and inert ingredients within the allowable tolerance levels and the disinfecting composition expressed from the wipe contains active ingredients within the allowable tolerance levels. Once applied to the surface, the antimicrobial disinfecting composition is allowed to remain on the surface for a period of time. The antimicrobial composition may be applied to the surface and allowed to dry or may alternatively be dried by wiping the surface with a dry wipe or wiping device, which is preferably unused.

When the wipe or disinfecting composition of the present invention is used to wipe a surface, disinfection is achieved in less than 4 minutes, generally 3 minutes or less and specifically in 90 seconds or less. It will be understood by those of ordinary skill that the antimicrobial disinfecting composition remains in contact with the surface requiring disinfection for a time sufficient to cause disinfection to occur. It has been discovered that the composition of the present invention is effective against many different microbes, including, but not limited to.

In yet another embodiment, the disinfectant composition may be used as a hand sanitizer. When used as a hand sanitizer, the biocides of the present disclosure can be combined with any of the ingredients described above. In one embodiment, for instance, the biocides may be combined with a solvent, such as water and/or an alcohol. In one particular application, a foaming agent may be added that causes the composition to foam when pumped from a dispenser. The foaming agent may comprise any suitable foaming agent that is compatible with the biocides. In one embodiment, for instance, the foaming agent may comprise a dimethicone or other similar agents that may cause the hand sanitizer to foam.

In one embodiment, the disinfectant composition may be used for disinfection of instruments, such as for pre-cleaning and disinfection or for terminal, high-level disinfection of a device, medical instrument or endoscope. In one embodiment, when the instrument is treated in a manual process, the disinfectant composition could be applied by immersing the instrument in the appropriate concentration of the disinfectant composition. For instance, plastic or metal containers, stainless steel sinks, or any other suitable container may be used as a vessel to hold the disinfectant composition. In one embodiment, complete immersion of the instrument or device or endoscope, including voids, lumens and hollow sections, may be necessary. When used for disinfection of instruments such as endoscopes, the channels of the endoscope and other instruments may need to be flushed. In general, after disinfection the instrument must be rinsed and flushed thoroughly with water, preferably with significant quantities of water.

In applications involving instruments, the appropriate concentration of the disinfectant composition may be from about 500 mg/L to about 25,000 mg/L, such as from about 1,000 mg/L to about 23,000 mg/L. For precleaning, the preferred concentration of the disinfectant composition may be from about 500 mg/L to about 10,000 mg/L, such as from about 1,000 mg/L to about 9,000 mg/L, such as from about 2,000 mg/L to about 8,000 mg/L, such as from about 3,000 mg/L to about 7,000 mg/L, such as from about 4,000 mg/L to about 6,000 mg/L. For high level disinfection, the preferred disinfectant composition concentration may be from about 5,000 mg/L to about 25,000 mg/L, such as from about 8,000 to about 23,000 mg/L, such as from about 10,000 to about 20,000 mg/L. In embodiments in which the instrument is immersed in the disinfectant composition, the necessary contact time may range from about 10 minutes to about 60 minutes, preferably from about 15 minutes to about 30 minutes. The necessary contact time may be adjusted based on the targeted disinfection level. In yet another embodiment, the disinfectant composition may be used for the disinfection of instruments in an automated washer-disinfector.

Various different microorganisms may be killed or controlled in accordance with the present disclosure. For instance, the disinfectant composition of the present disclosure can control gram positive bacteria, gram negative bacteria, and the like. In addition to bacteria, the disinfectant composition of the present disclosure can also kill and control the growth of various other microorganisms, such as viruses, spores, mycobacteria, and the like. Examples of particular microorganisms that may be killed or controlled in accordance with the present disclosure include Staphylococcus aureus, Streptococcus pneumoniae, Pseudomonas aeruginosa, Serratia marcescens, Salmonella enteritidis, Neisseria gonorrhoeae, Escherichia coli, Enterococcus hirae, Acinetobacter baumannii, Listeria monocytogenes, Enterobacter gergoviae, Klebsiella pneumoniae, Burholderia cepacia, Pseudomonas putida, Kocuria rhizophila, Candida albicans, Saccharomyces cerevisiae, Aspergillus brasiliensis, Penicillium funiculosum, Eupenicillium levitum, Bacillus cereus, Bacillus subtilis, Clostridium difficile, Clostridium perfringens, Mycobacterium tuberculosis, Mycobacterium terrae, Mycobacterium avium, Poliovirus, Adenovirus, Norovirus, Vaccinia virus, Influenza virus, Hepatitis B virus, Human Immunodeficiency virus, Human papilloma virus, or mixtures thereof.

### EXAMPLES

To demonstrate the synergistic effect the following example was performed.

Test Organism Preparation

The target organism Pseudomonas aeruginosa ATCC 15442 was taken from freezer stocks and grown for 24 hours on tryptone soy agar (TSA) at 37° C. A second subculture was produced from the first and grown with the same conditions. A test suspension was then created by adding loopfuls of organism to tryptone buffered saline and adjusting the cell concentration to 1×10⁸ and 5×10⁸ CFU/ml using an internally established calibration curve spectrophotometer at a wavelength of 600 nm. To establish the precise CFU/ml a 1 ml aliquot was then taken from the test suspension and serially diluted down to 10⁻⁶ and 10⁻⁷, 1 ml of each dilution was then plated in duplicate using the pour plate method on to TSA. The plates were then incubated for 24 hours at 37° C. and enumerated.

Test Sample Preparation

For each biocide tested a series of 3 samples were prepared in sterile distilled water,

Test sample 1—Biocide alone (to measure basic efficacy of the biocide)

Test sample 2—Biocide in combination with polyglyceryl-10 caprylate/caprate (to measure the efficacy of the combination of biocide and polyglycerol ester)

Control—A control sample of polyglyceryl-10 caprylate/caprate was prepared in deionized water to measure the efficacy of polyglycerol ester alone.

Each test sample was prepared at a concentration 10% higher than that of the target concentration to account for the dilution effect from the addition of the test organism suspension during the test procedure.

Test Procedure

A test mixture was prepared by adding a 0.1 ml aliquot of test organism suspension to a tube followed by 0.9 ml of test sample (prepared as above). The combination was then mixed and a timer started immediately. Each test mixture was allowed to sit for a specified contact time shown in Table 1.

TABLE 1
(Contact Times)

| Biocide | Contact time |
|---|---|
| Dodecyledimethylammonuim chloride | 5 minutes |
| N-(3-aminopropyl)-N-dodecylpropane-1,3-diamine | 5 minutes |
| Chlorhexidine | 5 minutes |
| Bis(2-N,N-dimethyl-N-alkyl ammonium ethylether) | 5 minutes |
| dichloride | |
| Isopropanol | 5 minutes |

Upon achieving the specified contact time the test mixture was deactivated by adding a 0.1 ml aliquot of the test mixture to 0.9 ml of neutralizing broth and the whole solution mixed. The solution was left for 5 minutes to ensure the action of the biocide was effectively neutralized.

To quantify the surviving number of organisms in the neutralized test mixture, 4×0.025 ml aliquots were taken and spot plated onto the surface of dried TSA. The plates were then incubated for 24 hours at 37° C.

Counting and Calculation of Log Reductions

Limits of Detection (LOD)

Depending on the dilution parameters of a method and the techniques used to enumerate cells, specific limits of detection must be set to ensure reliable enumeration.

For counting of pour plates, colonies from the incubated plates were enumerated using the lower count limit of <10 and the upper count limit of >330. For example, if a plate had 7 visible colonies countable, <10 would be recorded and 10 would be used for the calculation. For the upper limit, if 407 colonies were counted on a plate, >330 would be recorded and 330 would be used for the calculation.

For spot plating, colonies from the incubated plates were enumerated using the lower count limit of <1 and the upper count limit of >150. For example, if a plate had 0 visible colonies, <1 would be recorded and 1 would be used for the calculation. For the upper limit, if 156 colonies were counted on a plate, >150 would be recorded and 150 would be used for the calculation.

When reporting the final log reduction value, if a lower limit of detection has been used to make the calculation a “>” value will be reported for example “>5.02 log reduction”, while if upper limit of detection has been used to make the calculation a “<” value will be reported for example “<2.92 log reduction”.

Enumeration and calculation of N (Test organism suspension) and No

$$N = \frac{C}{( {n}_{1} + 0.1 {n}_{2} ) 1 {0}^{- 6}}$$

Where
C is the sum of viable count values
n₁ is the number of viable count values for the lower dilution, i.e. 10⁻⁶
n₂ is the number of viable count values for the higher dilution, i.e. 10⁻⁷
10⁻⁶ is the dilution factor corresponding to the lower dilution

For example:

$$N = \frac{168 + 213 + 20 + 25}{( 2 + 0.1 \times 2 ) 1 {0}^{- 6}} = \frac{426}{2.2 \times 1 {0}^{- 6}} = 1.9363 \times 1 {0}^{8} = 1.9 \times 1 {0}^{8} cfu / ml$$

N₀ is the number of cells per ml in test mixture at the beginning of contact time. It is one-tenth of the weighted mean of N due to the tenfold dilution by the addition of the test product. In this example N₀ is therefore 1.9×10⁷ cfu/ml.

Enumeration and Calculation of T (Test Mixture)
First, the mean average of cfu per 0.025 ml spots was established using the below calculation,

$$T = ( \frac{{d}_{1}}{4} )$$

### Where

d₁ is sum of viable count values from 4 spots

### Example

$$T = \frac{29 + 25 + 31 + + 33}{4} = \frac{118}{4} = 2 9.5 cfu / 0.025 ml$$

This was then multiplied by 40 to establish cfu/ml;
Example;

T=29.5×40=1180 cfu/ml
During the neutralization step, the test mixture underwent a tenfold dilution. To account for this a final ten times multiplication is applied;

T=1180×10=11800=1.18×10⁴ cfu/ml

Log Reduction Calculations (N₀−T)
Before calculating the log reduction both N₀ and T were converted into a logarithm base 10 value. For example;

N₀=1.9×10^{7=7.28} log 10

T=1.18×10⁴=4.07 log 10
To calculate the final log reduction the following calculation was used;

N₀−T=Log Reduction

For example;

7.28−4.07=3.21

The final log reduction for this example is 3.21

### Example 1

The test procedure outlined above was used to test for synergy between polyglyceryl-10 caprylate/caprate (PG1000) and the various biocidal agents listed in Table 1. Polyglyceryl glyceryl-10 caprylate/caprate showed little or no activity at 100 ppm, as is reported in Table 2 below. Varying concentrations were prepared and were tested at 5 mins for the presence of Pseudomonas aeruginosa. As is shown in Table 2 below the amounts of the biocidal ingredient and PG10CC where there was an initial indication of synergy between the biocidal agent and PG10CC. The calculated Log reduction is in Pseudomonas aeruginosa for the various mixtures are shown in Table 2.

TABLE 2

| Sample (Concentration - ppm) | Log Reduction |
|---|---|
| PGE Control (100 ppm) | <2.92 |
| Dodecyledimethylammonuim chloride (20 ppm) | 3.88 |
| Dodecyledimethylammonuim chloride (20 ppm) + | 5.09 |
| PGE (10 ppm) | |
| N-(3-aminopropyl)-N-dodecylpropane-1,3-diamine | 2.98 |
| (50 ppm) | |
| N-(3-aminopropyl)-N-dodecylpropane-1,3-diamine | 5.02 |
| (50 ppm) + PGE (37.5 ppm) | |
| Chlorhexidine (65 ppm) | 3.44 |
| Chlorhexidine (65 ppm) + PGE (37.5 ppm) | 4.6 |
| Bis(2-N,N-dimethyl-N-alkyl ammonium ethylether) | 3.63 |
| dichloride (5 ppm) | |
| Bis(2-N,N-dimethyl-N-alkyl ammonium ethylether) | 4.85 |
| dichloride (5 ppm) + PGE (25 ppm) | |
| Isopropanol (16%) | <2.85 |
| Isopropanol (16%) + PGE (12.5 ppm) | 3.25 |

While the invention has been described above with references to specific embodiments thereof, it is apparent that many changes, modifications and variations can be made without departing from the invention concept disclosed herein. Accordingly, it is intended to embrace all such changes, modifications, and variations that fall within the spirit and broad scope of the appended claims.

1. A disinfecting composition comprising
(i) a biocidal agent; and
(ii) a polyglycerol ester,
wherein the polyglycerol ester is present in an amount to sufficiently increase the efficacy of the biocidal agent as compared to the biocidal agent alone, and the increase is greater than the additive effect of the biocidal activity of the biocidal agent and polyglycerol ester taken alone.

2. The disinfecting composition according to claim 1, wherein the weight ratio of the polyglycerol ester to the biocidal agent is in the range of 0.00001 to 10.0.

3. The disinfecting composition according to claim 1, wherein the biocidal agent comprises a quaternary ammonium compound, a tertiary amine, a guanide, a biguanide, an alcohol, a phenolic compound, an organic acid, a peroxide, a peracid, an iron chelator, a pyridine compound, an iodine compound or mixtures thereof.

4. The disinfecting composition according to claim 3, wherein the tertiary amine comprises a (C₈-C₁₆) alkyl tertiary amine.

5. The disinfecting composition according to claim 3, wherein the biocidal agent comprises a quaternary ammonium compound.

6. The disinfecting composition according to claim 5, wherein the alkyl quaternary ammonium compound comprise a di C₈₋₁₈ alkyl dimethyl ammonium compound or a benzyl C₈₋₁₈ alkyl dimethyl ammonium compound.

7. The disinfecting composition according to claim 5, wherein the quaternary ammonium compound comprises a bis(2-N,N-dimethyl-N-alkyl ammonium ethylether) compound.

8. The disinfecting composition according to claim 5, wherein the quaternary ammonium compound has a salt anion, wherein the anion comprises a halide, a carbonate, a bicarbonate/carbonate, a carboxylate, sulfonate or a phosphate.

9. The disinfecting composition according to claim 3, wherein the biocidal agent comprises a guanide.

10. The disinfecting composition according to claim 9, wherein the guanide comprises polyhexamethylene monoguanide, polyhexamethylene biguanide or chlorhexidine.

11. The disinfecting composition according to claim 3, wherein the biocidal agent comprises an acid.

12. The disinfecting composition according to claim 3, wherein the biocidal agent comprises para-chlorometaxylenol, 2-pyridinol-1-oxide (HPNO), octenidine, or povidone-iodine.

13. The disinfecting composition according to claim 1, wherein the polyglycerol ester comprises a polyglycerol ester derived from (a) a polyglycerol component built up from 2 to 12 molecules of glycerol, based on an average, and (b) a fatty acid comprising a caprylic acid, capric acid, lauric acid, myristic acid, palmitic acid, stearic acid, arachidic acid, behenic acid, lignoceric acid, cerotic acid, oleic acid, or decaoleic acid.

14. The disinfecting composition, according to claim 13, wherein the polyglyceryl fatty ester comprises one or more of a polyglyceryl-10 laurate, polyglyceryl-10 decaoleate; polyglyceryl-3 monostearate; polyglyceryl-6 distearate, polyglyceryl-10 stearate; polyglyceryl-10 oleate; polyglyceryl-10 dipalmitate, or polyglyceryl-10 caprylate/caprate.

15. A method for increasing the efficacy of a biocidal agent in a disinfecting solution, said method comprising providing a biocidal agent, adding an effective amount of a polyglycerol ester to the biocidal agent to increase the efficacy of the biocidal agent as compared to an equal amount of biocidal agent without the polyglycerol ester.

16. An end-use formulation comprising a biocidal agent according to claim 1, comprising a hard surface cleaner, a hand and skin sanitizer, a hand and skin cleaner, a pre-disinfectant cleaner for instruments, a sterilizing and high-level disinfectant composition, a laundry detergent, or a fabric and upholstery cleaning agent.
